(19) United States
(12) Patent Application Publication
(10) Pub. No.: US 2004/0109943 A1
(43) Pub. Date: Jun. 10, 2004

(54) Latent hardener, manufacturing method for latent hardener, and adhesive

(76) Inventors: Takayuki Matsushima, Kanuma-shi (JP); Masao Saito, Kanuma-shi (JP)

Correspondence Address: Welsh & Katz, Ltd., Eric D. Cohen, 22nd Floor, 120 South Riverside Plaza, Chicago, IL, 60606, US

(21) Appl. No.: 10/309,688

(22) Filed: Dec. 4, 2002

(51) Int. Cl. B05D 7/12

(52) U.S. Cl. 427/212

(57) ABSTRACT

An adhesive of the present invention has a silane coupling agent, an epoxy resin and a latent hardener where hardener particles including metal chelate are covered by capsules to harden under the condition of low temperature within short time with a high preserving property. Since the hardener particles are covered by capsules, polymerization reaction of the epoxy resin hardly takes place at ambient temperature, but the capsules are broken when the adhesive is heated, thereby forming cation where the metal chelate constituting the hardener particles reacts with a silane coupling agent, thereby hardening the adhesive upon cationic polymerization of the epoxy resin by the cation.

### BACKGROUND OF THE INVENTION

1. Field of the Invention

The present invention relates to an adhesive and, more particularly, to a latent hardener used for an adhesive by which semiconductor chip and TCP (tape carrier package) are connected to substrates by means of a thermal compression bonding.

2. Description of Related Art

Adhesives containing an epoxy resin as a thermosetting resin have been conventionally used in connecting semiconductor chips onto a substrate or in manufacturing electric apparatuses by connecting TCP to LCD (liquid crystal display).

The reference numeral 111 in FIG. 7(a) shows an LCD, and the LCD 111 has a glass substrate 112 and ITO (indium tin oxide) electrodes 113 arranged on the glass substrate 112. In connecting the LCD 111 to a TCP which will be mentioned later, an adhesive is firstly applied on the surface of the side to which the ITO electrodes 113 of the LCD 111 are arranged. The reference numeral 125 in FIG. 7(b) shows an adhesive applied on the LCD 111.

The reference numeral 115 in FIG. 7(c) shows a TCP and the TCP 116 has a base film 116 and metal wirings 117 arranged on the surface of the base film 116. The side on which the metal wirings 117 of the TCP 115 are arranged is disposed to an adhesive 125 on the LCD 111, and after being positioned, the side to which the metal wirings 117 of the TCP 115 are arranged is pushed to the adhesive 125.

When heated as pushed in such a state, the adhesive 125 softens, and the metal wirings 117 push away the softened adhesive 125, thereby attaching to the surface of the ITO electrodes 113.

A hardener such as imidazole polymerized of an epoxy resin by heating is generally added to the adhesives mentioned as above, and when heating is further continued in a state where the metal wirings 117 are attached to the ITO electrodes 113, the epoxy resin is polymerized by a catalytic reaction of the hardener to harden the adhesive 125.

The reference numeral 101 in FIG. 7(c) shows an electric apparatus in a state where the adhesive 125 is hardened. In the electric apparatus 101, the TCP 115 and the LCD 111 are fixed by the hardened adhesive 125 while the metal wirings 117 are attached to the electrodes 113. Accordingly, the TCP 115 and the LCD 111 are connected to each other electrically and mechanically.

However, when the above adhesive is hardened, it is necessary to heat the adhesive at the temperature of as high as not lower than 180° C. and, if the pattern of the metal wiring 117 is fine, there may be the case where deformation such as elongation or warp is resulted in the TCP 115 upon heating. Such a problem may be solved when heating temperature is lowered, but time required for the heating treatment becomes longer and productivity lowers.

With regard to adhesives having excellent hardening property at low temperature, radically polymerizable resins such as acrylate and adhesives where a radical polymerization initiator have been developed in recent years but such adhesives are inferior in electric characteristics and heat resistance in a hardened state to an adhesive using an epoxy resin is used.

The present invention has been created for solving the above-mentioned inconveniences in the prior art, and its object is to provide an adhesive able to be hardened under the condition of lower temperature and short time and also has excellent preserving property.

The inventor of the present invention paid his attention to a means where commonly used hardeners are not used but an epoxy resin is subjected to a cationic polymerization and carried out repeated investigations and, as a result, he has found a method where a silane compound having at least one alkoxy group in a structure (a silane coupling agent) and a metal chelate (or a metal alcoholate) are added to an adhesive and the epoxy resin is polymerized (cationically polymerized) by cation produced by the reaction of the metal chelate with the silane coupling agent.

The step of hardening of the epoxy resin by an adhesive to which metal chelate and silane coupling agent are added will be illustrated by the following reaction formulae (1)˜(4).

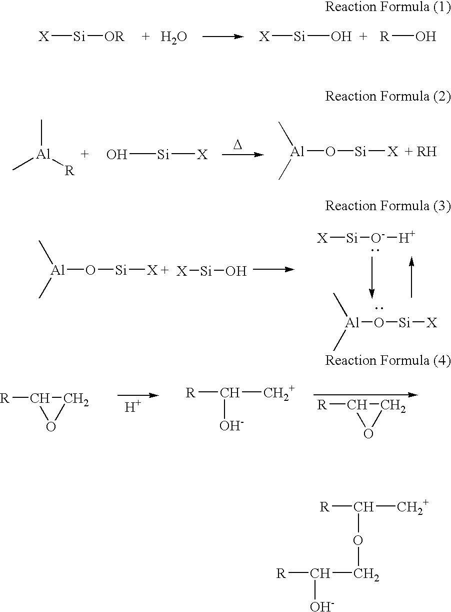

As shown in the reaction formula (1), a silane compound having at least one alkoxy group reacts with water in the adhesive whereupon the alkoxy group is hydrolyzed to give a silanol group.

When the adhesive is heated, the silanol group reacts with metal chelate such as aluminum chelate and the silane compound is bonded to the aluminum chelate (the reaction formula (2)).

After that, as shown in the reaction formula (3), another silanol remaining in the adhesive in an equilibrium reaction is arranged to the aluminum chelate to which the silanol is bonded whereupon Brøonsted acid points are produced and, as the reaction formula (4) shows, an epoxy ring located at the end of the epoxy resin is opened by the activated proton and is polymerized with an epoxy ring of another epoxy resin (cationic polymerization). As such, when a silane coupling agent and a metal chelate are added to an adhesive, a thermosetting resin such as epoxy resin is cationically polymerized. Since the reactions as shown by the reaction formulae (2)˜(4) proceed at lower temperature than the temperature (180° C.) at which the conventional adhesives are hardened, the adhesive as mentioned above hardens at lower temperature within shorter time than in the case of the conventional ones.

However, when metal chelate or metal alcoholate is directly added to an adhesive together with a silane coupling agent, polymerization reaction of an epoxy resin proceeds even at ambient temperature and viscosity of the adhesive becomes high.

Under such circumstances, the present inventors have carried out further and intensive investigations, and, as a result, they have found a method where the metal chelate is sealed into a capsule comprising a resin component which does not react with an epoxy resin at ambient temperature and added to an adhesive as the so-called latent hardener.

### SUMMARY OF THE INVENTION

The present invention has been constituted on the basis of the above-mentioned findings. A latent hardener according to the present invention includes a hardener particle mainly including either or both of metal chelate and metal alcoholate; and a capsule covering the surface of the hardener particle. In the latent hardener according to this invention, the capsule may be formed in such a manner that resin particles having smaller average particle size than that of the hardener particles are adhered on the surface of the hardener particles and fused.

According to an embodiment of the invention, the metal chelate is made of aluminum chelate, where the metal alcoholate is made of aluminum alcoholate. The capsule is also mainly made of a fluorine resin. With such a latent hardener, a melting point of the resin particle is from 30° C. to 350° C.; a thermal decomposition temperature of the resin particle is from 50° C. to 500° C.; a softening temperature of the resin particle is from 0° C. to 300° C., a glass transition temperature of the resin particle is from −40° C. to 300° C.

In another aspect of this invention, a manufacturing method for a latent hardener having hardener particles and a capsule covering the surface of the hardener particles, includes the steps of: manufacturing the hardener particles; and forming a capsule in adhering the capsule material formed in a powder shape having a smaller average particle size than that of the hardener particle on the surface of the hardener particle and in melting the capsule material at a state that the capsule material is being adhered on the surface of the hardener particle.

According to a preferred embodiment of the invention, the capsulation step has a mixing step where the hardener particles and the resin particles are mixed so that the resin particles are adhered on the surface of the hardener particles and a stirring step where the hardener particles in a state of being added with the resin particles are stirred so that the resin particles are fused. The ratio of the average particle size of the hardener particles to the average particle size of the resin particles can be 100:80 or more, and preferably, 100:50 or more.

In another aspect of the invention, an adhesive includes a thermosetting resin, a silane coupling agent, and a latent hardener as mentioned above.

### BRIEF DESCRIPTION OF THE DRAWINGS

FIGS. 1(A) to 1(C) are illustrations showing an example of the manufacture of a latent hardener of the present invention.

FIGS. 2(A) and 2(B) are illustrations showing an example of a step for the manufacture of an adhered film using the adhesive of the present invention.

FIGS. 3(A) to 3(D) are illustrations showing the first half of the step for connecting an LCD to a TCP using the adhesive of the present invention.

FIGS. 4(E) and 4(F) are illustrations showing the second half of the step for connecting the LCD to the TCP.

FIG. 5 is a plane figure which illustrates the state of positioning of the TCP on the LCD.

FIGS. 6(A) to 6(C) are illustrations showing another example of a step for connecting the TCP to the LCD using the adhesive of the present invention.

FIGS. 7(A) to 7(C) are illustrations showing the first half of a step for connecting the LCD to the TCP using the adhesive of the prior art.

### DETAILED DESCRIPTION OF THE PREFERRED EMBODIMENTS

The present invention is constituted as mentioned above and, when the resin particles and the hardener particles are mixed and stirred, many resin particles are electrostatically adhered on the surface of a hardener particle. When the hardener particles in this state are stirred at high speed in a stirring apparatus, the resin particles electrostatically adhered on the surface of the hardener particles collides with blades and inner walls of the stirring apparatus and also with the resin particles, etc. on the surface of other hardener particles and then the resin particles are melted or driven into a core substance (hardener particle) by energy resulted by a physical impacts. The melted resin particles are unified and there is formed a capsule coating the surface of the hardener particle.

When an adhesive is prepared by mixing the latent hardener as above with a silane coupling agent and an epoxy resin to produce an adhesive, all of the surfaces of the hardener particles are covered with capsules at ambient temperature and polymerization reaction of the epoxy resin does not take place whereby preserving property of the adhesive is high while, when the adhesive is heated, the capsules are softened or melted and mechanical strength of the capsules becomes significantly low. Therefore, under the state where the adhesive is heated, the capsules are easily broken by physical impacts such as thermal expansion of the hardener particles and pressurization upon compression bonding by heat whereupon the hardener particles are released into the adhesive.

When heating is further carried out under such a state, a metal chelate which is a main component in the hardener particles reacts with a silane coupling agent in the adhesive by heating whereupon cation is produced, the epoxy resin is polymerized by the cation (cationic polymerization) and the adhesive hardens.

Reaction of the hardener particles with the silane coupling agent takes place at lower temperature than the temperature for thermal setting of the conventional adhesive (180° C. or more) and, therefore, the adhesive of the present invention hardens at lower temperature and within shorter time than the conventional adhesives.

For making the contacting area with an epoxy resin large, it is preferred that an average particle size of hardener particles is small but, when an average particle size of the hardener particles is too small, its difference in the particle size from the resin particles becomes small and formation of capsule becomes difficult and, therefore, it is preferred that an average particle size of the hardener particles is from 0.5 μm to 50 μm.

Incidentally, as mentioned above, in manufacturing a latent hardener by mixing and stirring of resin particles and hardener particles, a hybridizer apparatus (such as “NHS-0” (trade name) manufactured by Nara Kikai Seisakusho K. K.) may be used. In that case, compounding ratio of the hardener particles to the resin particles can be calculated by the following formula (1).

M/m=D×F/(4×d×f) Formula (1)

In the above formula (1), M is a compounding amount (g) of the hardener particles; m is a compounding amount (g) of the resin particles; D is an average particle size (μm) of the hardener particles; d is an average particle size (μm) of the resin particles; F is specific gravity of the hardener particles; and f is specific gravity of the resin particles. Incidentally, specific gravity means the ratio of density of each substance to density of water at 4° C. which is a standard substance. However, the above formula (1) is a theoretical formula and the optimum compounding ratio of the hardener particles to the resin particles can be determined depending upon the circumstance.

When a thermoplastic resin is added to an adhesive, cohesive force of the adhesive increases due to the property of the thermoplastic resin whereby the adhesive property of the adhesive is further enhanced. When a substance having a high polarity is used as a thermoplastic resin, there is observed not only that the thermoplastic resin is incorporated into the hardening reaction of the resin component but also that it is bonded to an inorganic material via a silane coupling agent. Accordingly, the outcome is not only that hardening property becomes high but also that its affinity to a thing to be adhered comprising an inorganic material becomes higher.

As hereunder, an adhesive of the present invention will be illustrated in detail.

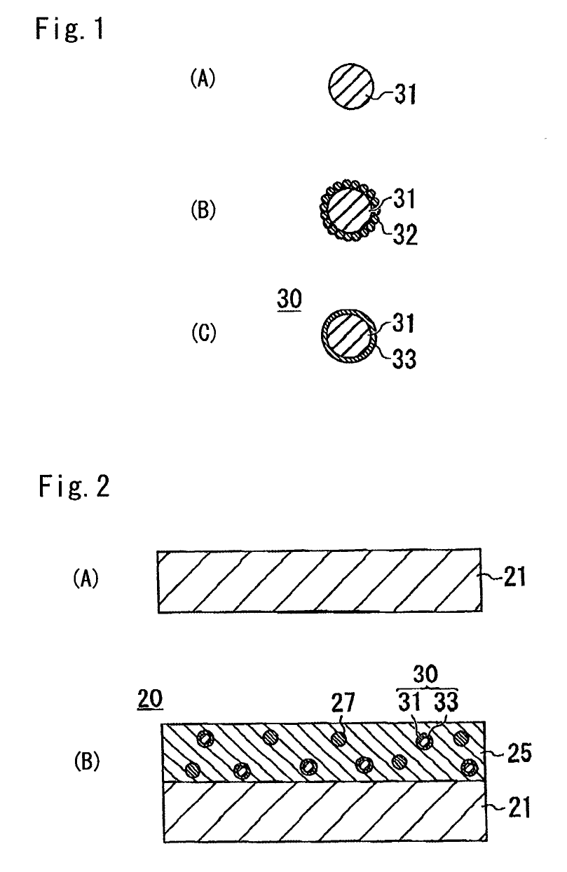

Firstly, aluminum chelate as a metal chelate is dissolved in an organic solvent to prepare a solution in which the metal chelate is dissolved and the metal chelate solution is spray-dried using a spray-drying apparatus to give hardener particles (spray-drying method). The reference numeral 31 in FIG. 1(A) shows a hardener particle.

Then there is prepared a powdery resin (resin particles) which satisfies any of the conditions that melting point is from 30° C. to 350° C., thermal decomposition temperature is from 50° C. to 500° C., softening temperature is from 0° C. to 300° C. and glass transition temperature is from −40° C. to 300° C. Ratio of the average particle size of the hardener particles to the average particle size of the resin particles is made 100:80 or more.

After that, the hardener particles 31 and the resin particles are mixed in a predetermined compounding ratio and stirred in a mixing apparatus whereupon resin particles having smaller average particle size than hardener particle 31 are electrostatically adhered to the surface of the hardener particle 31 (mixing step). The reference numeral 32 in FIG. 1(B) shows a resin particle and the surface of one hardener particle 31 is covered with many resin particles 32.

When hardener particles 31 where resin particles 32 are electrostatically adhered on the surface are poured into a stirring apparatus (not shown) and stirred at high speed, the resin particles 32 on the surface of the hardener particles 31 collides with rotating blades or inner walls of the stirring apparatus and with resin particles 32 on the surface of other hardener particles 31 or rubbed against them, the resin particles 32 are melted by the heat generated thereby and the melted resin particles 32 are unified each other (stirring step).

The reference numeral 33 in FIG. 1(C) shows a capsule which is formed by unification of resin particles 32. The capsule 33 is formed in such a manner that it covers whole surface of the hardener particles 31, and a latent hardener 30 is constituted from the hardener particles 31 and the capsule 33.

Now, the adhesive of the present invention using the latent hardener 30 and a step for manufacturing an electric apparatus using the adhesive of the present invention will be illustrated. An epoxy resin as a thermosetting resin, a thermoplastic resin, a silane coupling agent, the latent hardener 30, electrically conductive particles and a solvent were mixed and stirred in a predetermined compounding ratio to prepare an adhesive. In such a state, the adhesive is pasty.

The reference numeral 21 in FIG. 2(A) shows a releasing film. When the adhesive in a predetermined amount is applied on the surface of the releasing film 21 and dried, solvent in the adhesive is evaporated whereupon a coated layer 25 of the adhesive is formed (FIG. 2(B))

The reference numeral 20 in FIG. 2(B) shows an adhesive film in a state where the coated layer 25 is formed. The reference numeral 27 in FIG. 2(B) shows electroconductive particles dispersed in the adhesive together with the latent hardener 30. In this state, the hardener particle 31 of the latent hardener 30 is sealed in the capsule 33, and a silane coupling agent in the adhesive constituting the coated layer 25 does not contact to the hardener particles 31. Therefore, no hardening reaction of the coated layer 25 takes place at ambient temperature.

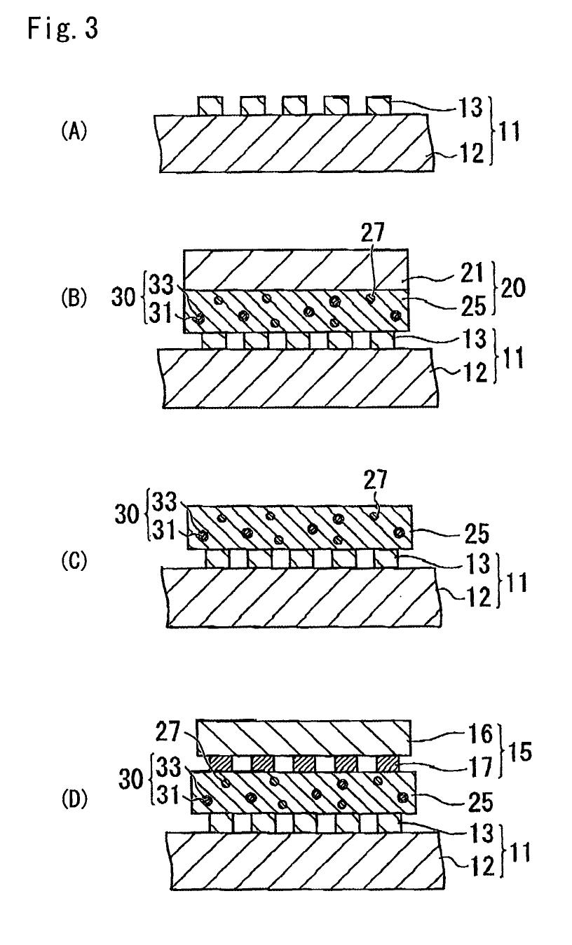

The reference numeral 11 in FIG. 3(A) shows LCD and the LCD 11 has a glass substrate 11 and a plurality of ITO electrodes 13 (indium tin oxide) formed on one side of the glass substrate 12. In this drawing, five ITO electrodes 13 are shown.

The coated layer 25 of an adhesive film 20 shown in FIG. 2(B) is pushed and attached to the part of the surface whereto TCP which will be mentioned later among the surfaces where ITO electrodes 13 of LCD 11 are formed (FIG. 3(B)). Adhesive force of a releasing film 21 to the coated layer 25 is made smaller than that of a coated layer 25 to ITO electrodes 13 and, therefore, the coated layer 25 remains on the LCD 11 when the releasing film 21 is released (FIG. 3(C)).

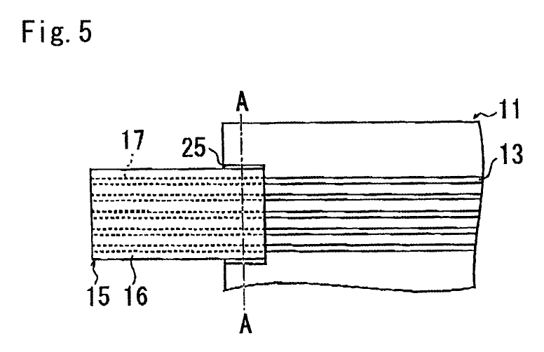

The reference numeral 15 in FIG. 5 shows TCP. The TCP 15 has a long-sized base film 16 and, on one side of the base film 16, there are arranged a plurality of narrow metal wirings 17 in the longitudinal direction of the base film 16 (here, five metal wirings 17 are shown). Each end of the longitudinal direction of the metal wirings 17 is positioned at each end of the longitudinal end of the base film.

FIG. 3(D) shows a cross-sectional view of FIG. 5 along the line A-A in which a surface of the side to which the metal wirings 17 of TCP 15 are arranged is faced to the side to which the ITO electrodes of LCD 11 are arranged while an end of the TCP 15 is faced to the coated layer 25 of the surface of the ITO electrode 13 whereby there is positioned in such a manner that the ITO electrode 13 of the LCD 11 and the metal wiring 17 of the TCP 15 face each other.

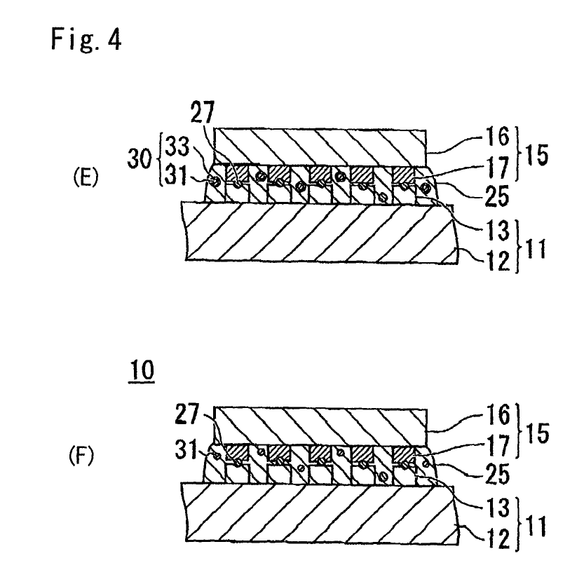

When the surface to which the metal wirings 17 of the TCP 15 is pushed and attached to the coated layer 25 in such a state and the whole is heated together with pressing the part where TCP 15 and LCD are layered, the coated layer 25 softens by heating, the metal wirings 17 push away the softened coated layer 25 by means of the pressure and the electrically conductive particles 27 in the remained coated layer 25 are sandwiched between the metal wirings 17 and the ITO electrodes 13 (FIG. 4(E)).

When heating with pressure is continued under such a state, the capsule 33 is fused or softened and mechanical strength of the capsule 33 becomes significantly weak. At that time, hardener particles 31 are thermally expanded by heating and, therefore, the capsule 33 where mechanical strength becomes weak is broken and the hardener particles 31 are mixed with an epoxy rein and a silane coupling agent in the coated layer 25.

When the hardener particles 31 are mixed with an epoxy resin and a silane coupling agent, aluminum chelate constituting the hardener particles 31 reacts with a silane coupling agent and cation is released into the coated layer 25. Polymerization of the epoxy resin suddenly proceeds by the cation (cationic polymerization) and the coated layer 25 hardens in such a state that the electrically conductive particles 27 is sandwitched (FIG. 4(F)) between the metal wirings 17 and the ITO electrodes 13.

The reference numeral 10 in FIG. 4(F) shows an electric apparatus in a state where the coated layer 25 is hardened. In the electric apparatus 10, it is not only that the metal wirings 17 and the ITO electrodes 13 are electrically connected via electrically conductive particles 27 but also that the LCD 11 and the TCP 15 are mechanically (or physically) connected by the hardened coated layer 25.

As such, in the adhesive of the present invention, it is not only that preserving property is excellent but also an epoxy resin is hardened by cationic polymerization, and accordingly, the adhesive is able to be hardened at lower temperature within a shorter time as compared with the case where a conventional hardener is used.

### EXAMPLES

Each of aluminum chelate (aluminum acetylacetonate manufactured by Kawaken Fine Chemical K. K.; “Alumichelate A (W)” (trade name)) and aluminum alcoholate (aluminum isopropylate manufactured by Kawaken Fine Chemical K. K.; “AIPD” (trade name)) was dispersed in methyl ethyl ketone which is a solvent to prepare a metal chelate solution containing 10% by weight of aluminum chelate and a metal alcoholate solution containing 10% by weight of aluminum alcoholate, respectively.

After that, each of the metal chelate solution and the metal alcoholate solution was spray-dried using a spray-drier (“GC-31” (trade name) manufactured by Yamato Labotech K. K.) under the condition of spray inlet temperature of 80° C., spray outlet temperature of 60° C., spray pressure of 1 kg/cm² and dry nitrogen gas flow rate of 0.5 m³/minute to prepare two kinds of powdery hardeners (hardener particles) (spray-drying method). Apart from that, there was prepared a powdery fluorine resin (“Lubron L-5” (trade name) manufactured by Daikin Industries; primary particle size: 0.2 μm; melting point: 327° C.) as the resin particles 32.

The above hardener particles 31 (20 parts by weight) and the above resin particles 32 (3 parts by weight) were mixed in a step of FIG. 1(A)(B) using “Hybridizer NHS-0” (trade name) manufactured by Nara Kikai Seisakusho K. K.) whereupon the resin particles 32 were electrostatically adhered on the surface of the hardener particles 31 (mixing step) and then the hardener particles 31 in a state of being adhered with the resin particles 32 were stirred under the condition of circumferential speed of 100 m/second, treating time of 5 minutes and treating temperature of 50° C. (stirring step) whereupon two kinds of latent hardeners 30 were prepared.

A phenoxy resin which is a thermoplastic resin (“YP 50” (trade name) manufactured by Toto Kasei K. K.) (50 parts by weight), a silane coupling agent (“A-187” (trade name) manufactured by Nippon Unicar K. K.) (1 part by weight), electrically conductive particles (2.5 parts by weight), each latent hardener (10 parts by weight) and an organic solvent were added to and dispersed in 50 parts of an epoxy resin of a bisphenol A type which is a thermosetting resin (“EP 828” (trade name) manufactured by Yuka Shell Epoxy K. K.) to prepare a pasty adhesive followed by subjecting to the step of FIGS. 2(A), 2(B) to prepare each of adhesive films 20 of Examples 1 and 2. Those adhesive films of Examples 1 and 2 were used for subjecting to each of the following test upon preservation at room temperature and test upon preservation at 40° C.

[Test Upon Preservation at Room Temperature]

After the TCP 15 and the LCD 11 were connected according to the steps of FIGS. 3(A) to 3(D) and FIGS. 4(E), 4(F) using the adhesive films 20 of Examples 1 and 2 and Comparative Examples 1 and 2, strength for releasing the TCP 15 from the LCD 11 was measured (initial releasing force).

Apart from that, the adhesive films 20 of Examples 1 and 2 and Comparative Examples 1 and 2 were preserved at room temperature (25° C.) for 1 day, 3 days and 7 days, the TCP 15 and the LCD 11 were connected by the same step using each of the adhesives films 20 after preservation and strength for releasing the TCP 15 from the LCD 11 was measured (releasing force after preservation).

[Test Upon Preservation at 40° C.]The adhesive film 20 was preserved under the same condition as the above “test upon preservation at room temperature” except that the temperature for preserving the adhesive film was changed from room temperature to 40° C. to connect the TCP 15 to the LCD 11 and then the strength for releasing after the preservation was measured.

In the above “test upon preservation at room temperature” and “test upon preservation at 40° C.”, the case where the degree of the releasing force after the preservation was 90% or more of the initial releasing force was evaluated as “excellent”, the case where that was from 80% or more but less than 90% was evaluated as “good”, where that was from 70% or more but less than 80% was evaluated as “fair” and the case where that was less than 70% was evaluated as “poor” and the result of the evaluation is mentioned in the following Table 1.

TABLE 1
(Result of Evaluation Test)

| | Preserved at room | | Preserved at | |
|---|---|---|---|---|
| | temperature for | | 40° C. for | |
| | 3 days | 7 days | 3 days | 7 days |
| Example 1 | excellent | excellent | excellent | good |
| Example 2 | excellent | excellent | excellent | good |
| Comparative Example 1 | poor | poor | poor | poor |
| Comparative Example 2 | poor | poor | poor | poor |

Comparative Examples 1 and 2 in the above Table 1 are the cases where the two kinds of hardener particles used in Examples 1 and 2 were added to the adhesive without formation of capsules.

Here, with regard to the TCP 15, used as that metal wirings 17 each having a width of 25 μm were arranged with an interval of 25 μm. With regard to the LCD 11, used was that ITO electrode 13 having a sheet resistance was 10 ohms per cm² of the surface area. They were heated for 10 seconds together with application of a load of 3 MPa to the part where TCP 15 and LCD 11 were overlaped so that the coated layer 25 was heated up to 130° C. to connect.

As will be apparent from the above Tables 1 and 2, the result of the evaluation was good both in “test upon preservation at room temperature” and “test upon preservation at 40° C.” in Examples 1 and 2 where the hardener particle 31 was coated on the capsule 33. On the other hand, in Comparative Examples 1 and 2 where the hardener particles were directly added to the adhesive without formation of capsules, the result of each of the evaluation tests was bad. From those results, it was confirmed that the adhesive of the present invention using the latent adhesive had excellent preserving property.

As hereinabove, although there were illustrated the cases where an adhesive film was prepared using an adhesive, the present invention is not limited thereto but, for example, an adhesive may be used also in its original pasty form.

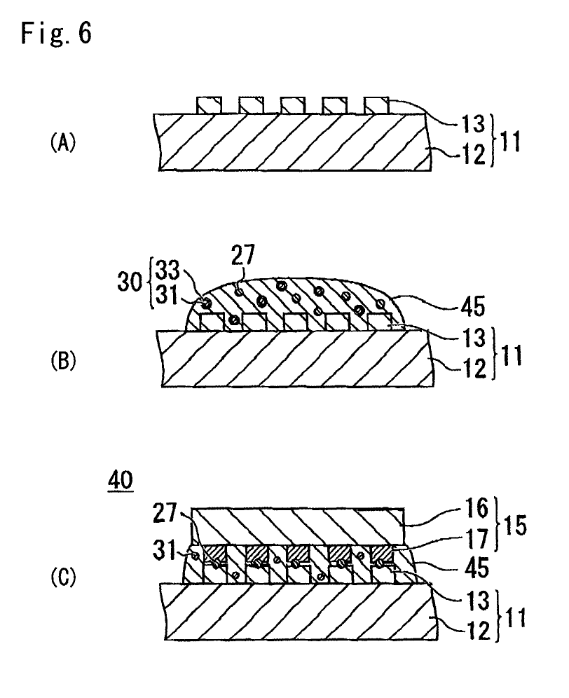

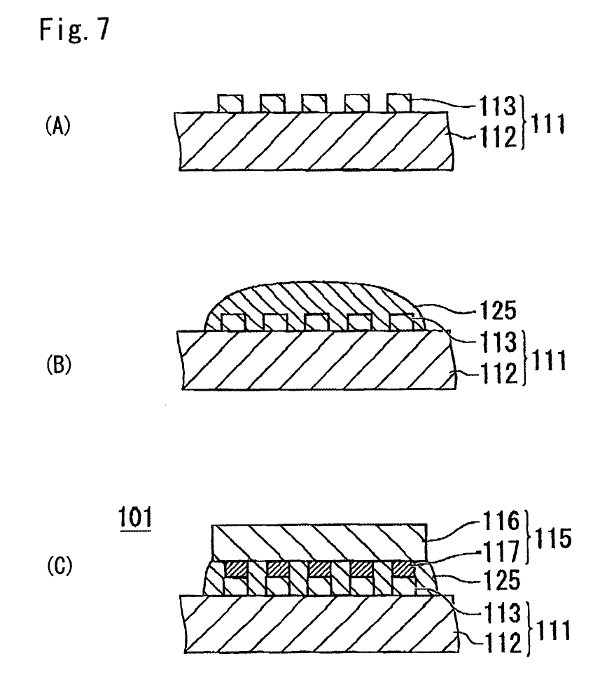

The reference numeral 11 in FIG. 6(A) shows the same LCD as that shown in FIG. 3(A) and, in connecting the TCP 15 to this LCD 11, an adhesive was first applied to the part to which the TCP 15 is connected among the surface of the ITO electrode 13 of the LCD 11 whereupon a coated layer 45 of an adhesive is formed (FIG. 6(B)).

After that, positioning of the TCP 15 was carried out in the step of FIG. 3(D) and then the TCP 15 and the LCD 11 were connected in the steps of FIG. 4(E) and (F) whereupon an electric apparatus 40 was prepared (FIG. 6(C)).

As hereinabove, although there were illustrated the cases where the TCP 15 and the LCD 11 were connected using an adhesive, the present invention is not limited thereto but may also be used for the cases where various electric apparatuses are used such as a case where a substrate and a semiconductor chip are connected.

Further, as hereinabove, although the cases where electrically conductive particles are dispersed in an adhesive were illustrated, the present invention is not limited thereto but, for example, an adhesive containing no electrically conductive particle is also included in the present invention.

With regard to a metal chelate constituting the hardener particle, various metal chelates such as zirconium chelate, titanium chelate and aluminum chelate may be used and, among them, a highly reactive aluminum chelate may be more preferably used. In addition, although the method for the manufacture of hardener particles by a spray-drying method was illustrated hereinabove, the present invention is not limited thereto.

Although there were illustrated hereinabove the cases where a fluorine resin having a melting point of 327° C. was used as resin particles, the present invention is not limited thereto but it is also possible to use various ones such as thermoplastic resin, cross-linked resin and gel-like resin so far as they satisfy any of the conditions that melting point is from 30° C. to 350° C., thermal decomposition temperature is from 50° C. to 500° C., softening temperature is from 0° C. to 300° C. and glass transition temperature is from −40° C. to 300° C.

With regard to the above resin, there may be used cross-linked acrylate resin (“Microgel” (trade name) manufactured by Nippon Paint K. K.), polymethyl methacrylate resin (“MP Series” manufactured by Soken Kagaku K. K.), benzoguanamine resin (“Epostar” (trade name) manufactured by Nippon Shokubai), silicone resin (“Tospearl” (trade name) manufactured by GE-Toshiba Silicone), etc.

In the capsules which were formed in such a manner that the resin particles having the above characteristics are melted, there may be the case where the resin constituting the resin particles are chemically denatured during the step of capsulation, and in that case, melting point, thermal decomposition temperature, softening temperature and glass transition temperature of the capsule may become outside of each of the above-mentioned temperatures.

Although there was illustrated hereinabove the case where an epoxy resin is used as a thermosetting resin, the present invention is not limited thereto. There may be used various ones such as urea resin, melamine resin, phenol resin, vinyl ether resin and oxetane resin so far as it is a resin which is able to be cationically polymerized and, when strength, etc. of the adhesive after thermal setting are taken into consideration, the use of an epoxy resin is preferred.

With regard to a silane coupling agent used in the present invention, it is preferred to use that which is shown by the following formula (5).

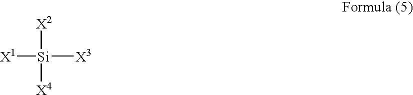

(In the above formula (5), at least one of the substituents X¹-X⁴ is an alkoxy group. The alkoxy group is preferably methoxy group or ethoxy group. Among the substituents X¹-X⁴ besides an alkoxy group, at least one is preferably that which has epoxy ring or vinyl group and, particularly preferably, a substituent having an epoxy ring is glycidyl group. An example of a substituent having vinyl group is methacryloxypropyl group. An example of a substituent having glycidyl group is glydoxypropyl group. The so-called silicate where all of the substituents X¹-X⁴ are alkoxy group may be used as well.)

With regard to a thermoplastic resin, various ones other than phenoxy resin such as polyester resin, polyurethane resin, polyvinyl acetal, ethylene vinyl acetate and rubbers (e.g., polybutadiene rubber) may be used as well.

It is also possible that various additives such as aging preventer, filler and coloring agent to the adhesive of the present invention.

Advantages of the present invention are that, in the adhesive of the present invention, hardener particles comprising metal chelate are covered by capsules and, therefore, polymerization reaction of an epoxy resin does not take place at ambient temperature and preserving property of the adhesive is high. In addition, the adhesive of the present invention hardens by a cationic polymerization reaction of an epoxy resin. Since a cationic polymerization reaction takes place at lower temperature than in the case of polymerization reaction using the conventional hardener, the adhesive of the present invention hardens at lower temperature within shorter time than in the case of the conventional adhesives.

What is claimed is:

1. A latent hardener comprising:
a hardener particle mainly including either or both of metal chelate and metal alcoholate; and
a capsule covering the surface of the hardener particle.

2. The latent hardener according to claim 1, wherein the metal chelate is aluminum chelate.

3. The latent hardener according to claim 1, wherein the metal alcoholate is aluminum alcoholate.

4. The latent hardener according to claim 1, wherein the capsule mainly comprises a fluorine resin.

5. The latent hardener according to any of claims 1, wherein the capsule is formed in such a manner that resin particles having smaller average particle size than that of the hardener particles are adhered on the surface of the hardener particles and fused.

6. The latent hardener according to claim 5, wherein melting point of the resin particle is from 30° C. to 350° C.

7. The latent hardener according to claim 5, wherein thermal decomposition temperature of the resin particle is from 50° C. to 500° C.

8. The latent hardener according to claim 5, wherein softening temperature of the resin particle is from 0° C. to 300° C.

9. The latent hardener according to claim 5, wherein glass transition temperature of the resin particle is from −40° C. to 300° C.

10. A manufacturing method for a latent hardener having hardener particles and a capsule covering the surface of the hardener particles, comprising the steps of:
manufacturing the hardener particles; and
forming a capsule in adhering the capsule material formed in a powder shape having a smaller average particle size than that of the hardener particle on the surface of the hardener particle and in melting the capsule material at a state that the capsule material is being adhered on the surface of the hardener particle.

11. The manufacturing method for the latent hardener according to claim 10, wherein the capsulation step has a mixing step where the hardener particles and the resin particles are mixed so that the resin particles are adhered on the surface of the hardener particles and a stirring step where the hardener particles in a state of being added with the resin particles are stirred so that the resin particles are fused.

12. The manufacturing method for the latent hardener according to any of claim 10 and claim 11, wherein the ratio of the average particle size of the hardener particles to the average particle size of the resin particles is 100:80 or more.

13. The manufacturing method for the latent hardener according to any of claim 10 and claim 11, wherein the ratio of the average particle size of the hardener particles to the average particle size of the resin particles is 100:50 or more.

14. An adhesive having a thermosetting resin, a silane coupling agent and a latent hardener mentioned in claim 1.
